(19) United States
(12) Patent Application Publication
(10) Pub. No.: US 2002/0154523 A1
(43) Pub. Date: Oct. 24, 2002

(54) Circuit for converting AC voltage into DC voltage

(76) Inventors: Thomas Duerbaum, Langerwehe (DE); Reinhold Elferich, Aachen (DE); Georg Sauerlaender, Aachen (DE)

Correspondence Address: U.S. Philips Corporation, 580 White Plains Road, Tarrytown, NY, 10591, US

(21) Appl. No.: 10/080,182

(22) Filed: Feb. 20, 2002

(30) Foreign Application Priority Data
Feb. 22, 2001 (DE) 10108431.5

(51) Int. Cl. H02M 1/12

(52) U.S. Cl. 363/45

(57) ABSTRACT

The invention relates to a circuit for converting AC voltage in DC voltage for one or two consumers (Rm, Ra), in which a first part of the current is led via a large induction coil (L50) and a first rectifier (Gm) and a second part of the current via a second rectifier (Ga) before the large induction coil in the input side. As a result of the division of the supplied current the induction coil (L50) can be dimensioned accordingly smaller for smoothing the output voltage and, despite this, the circuit can at the same time satisfy relevant standard specifications.

The invention relates to a circuit for converting an AC voltage into an uncontrolled DC voltage for at least one consumer, comprising

an AC power supply having two external connections and at least two internal connections,

a rectifier module whose two inputs are connected to a respective internal connection of the AC power supply and which has two output lines with external connections for coupling at least one consumer to them,

at least an induction coil arranged in at least one of the connection lines between the internal connections of the AC power supply and the rectifier module.

A plurality of electric or electronic devices need to have a DC voltage for their operation, which DC voltage is to be generated or rendered available from the AC voltage of the electricity mains. As a representation for such terminal devices is mentioned a television set (TV). The circuits for converting AC voltage into DC voltage installed in such sets are to satisfy certain requirements with respect to their conversion behavior, more particularly, with respect to the remaining part of mains harmonics. Such requirements are not least subject matter of standards, while in this respect more particularly the CEI/IEC 61000-3-2, SECOND EDITION, 2000-08 deserves mentioning, which as from the year 2001 is to be satisfied in Europe by terminal devices which have a power consumption exceeding 75 W.

To ensure the adherence to said quality standards, there are various possibilities with various optimal power ranges. For large powers from 500 W onwards, active solutions are predominant. In the smaller power range, on the other hand, there are often 50 Hz coils. They are relatively inexpensive, but also relatively large and heavy. These sizes or these concentrated numbers lead to problems with the available space on printed circuit boards, or to problems concerning the shock resistance of the manufactured devices.

Against this background it was an object of the present invention to provide a circuit for converting AC voltage into DC voltage for at least one consumer, which circuit ensures sufficient quality of the conversion behavior with limited space and expenditure.

This object is achieved by a circuit having the characteristic features of claim 1. Advantageous embodiments can be learnt from the dependent claims.

The circuit for converting AC voltage into DC voltage for at least one consumer additionally includes the following component parts:

(a) An AC voltage supply having two external connections (EA) and at least two internal connections (IA). The poles of an external AC voltage source can be connected to the external connections and this AC voltage can be tapped from the internal connections after a possible conversion by the AC voltage supply. In the simplest case there is no conversion in the AC voltage supply, and each external connector is connected directly via a line to a respective internal connection. The AC voltage supply, however, may also be, for example, a transformer in which the two external connectors are the connectors of the primary winding of the transformer and each secondary winding of the transformer renders two internal connectors available,

(b) A rectifier module of known structure whose two inputs are connected for the arrival of an AC voltage to a respective internal connector of the AC voltage supply and which has two output lines to which at least one consumer can be connected,

(c) At least one induction coil which is arranged in one of the connection lines which connect the internal connectors of the AC voltage supply to the rectifier module. The induction coil has for its object to smooth the recharging current or reduce the harmonic content of the recharging current, respectively.

The circuit is characterized in that at least a second rectifier module is available whose two inputs are each connected to an internal connector of the AC voltage supply and which includes two output lines for the connection of at least one consumer.

In the circuit according to the invention the power supplied as AC voltage from the exterior is led over two separate input paths. One path is led via the first rectifier module. In this path is situated in known manner an induction coil to cause a reduction to appear of the harmonic part of the recharging current. In addition, according to the invention a second input path is opened running via the second rectifier module. The consequent relief of the first input path occurring with an invariant total power consumption may be used for designing the induction coils in this path with accordingly smaller values. Based on the on-linear correlation between coil size and current I flowing through it, which can approximately be expressed by the value (L×I2/2) for the size of the coil, the size of the coil is made to diminish particularly because the inductance can become smaller. In this way it becomes possible to utilize induction coils having a drastically reduced size which can be used on printed circuit boards even when there is little space and which avoid problems with the shock resistance of the devices. Furthermore, the pattern of the current consumption from the AC voltage source, which pattern is created by the circuit according to the invention, is changed in an advantageous manner, so that standard specifications can be satisfied in a simple way and with reduced expenditure.

The circuit according to the invention may be complemented in various ways to obtain improved output signals. For example, the two output lines of at least one rectifier module, preferably of all the rectifier modules, can be coupled via a respective smoothing capacitor. This smoothing capacitor causes a suppression to occur of higher frequencies in the output voltage.

Furthermore, a diode may be included in at least one output line of one or all the rectifier modules to permit the current to flow only in one direction.

In a preferred embodiment of the circuit the output lines of the rectifier modules, which lines have the same polarity, are connected together. This means that the two rectifier modules are connected in parallel to supply power to a consumer to be connected.

As already observed, the AC voltage supply can in the simplest case be formed by continuous connecting lines between a respective external connection and an internal connection, thus not imply signal conversion. However, as an alternative, this AC voltage supply may also be formed by a transformer whose primary winding ends form the two external connections and whose connections of the—preferably two—secondary windings form four internal connections.

The invention will be further explained with the aid of the Figures by way of example, in which:

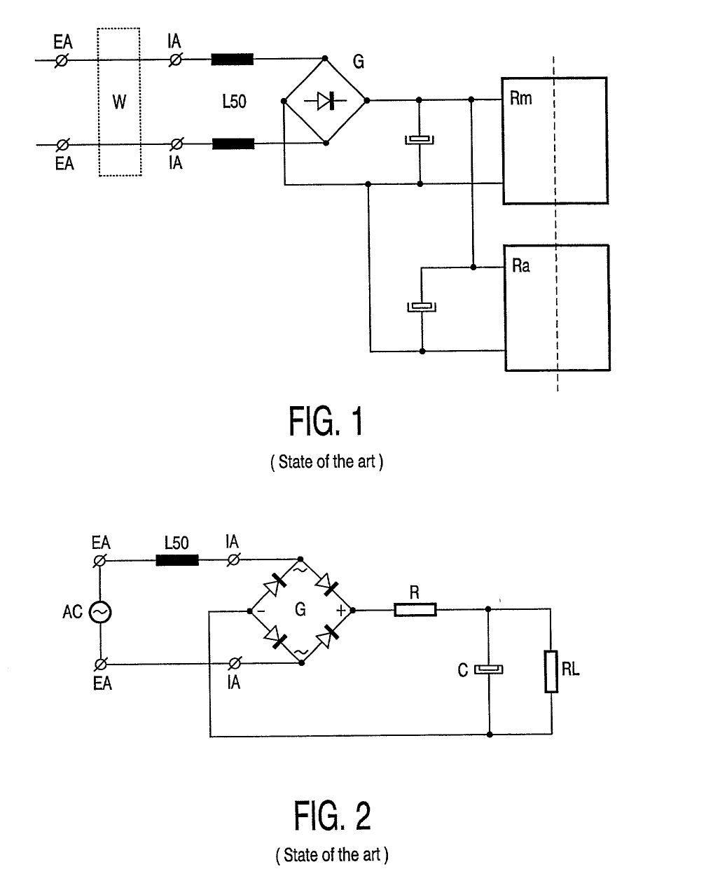

FIG. 1 shows a prior-art circuit for power supply of two consumers,

FIG. 2 shows a prior-art circuit for the power supply of one consumer,

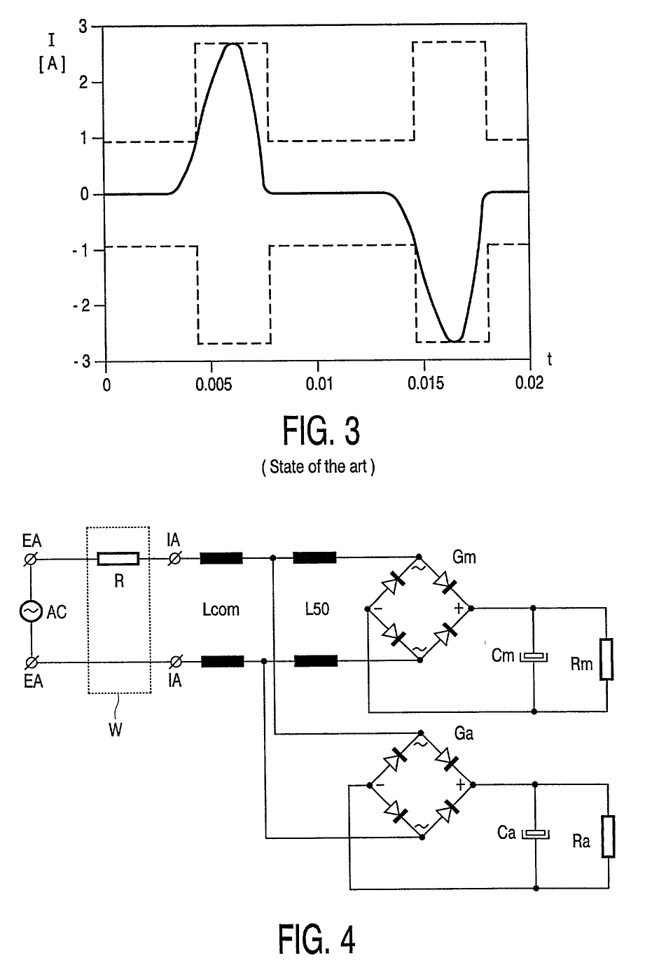

FIG. 3 shows the current consumption occurring in a circuit shown in FIG. 1 or 2,

FIG. 4 shows a first circuit according to the invention having two consumers,

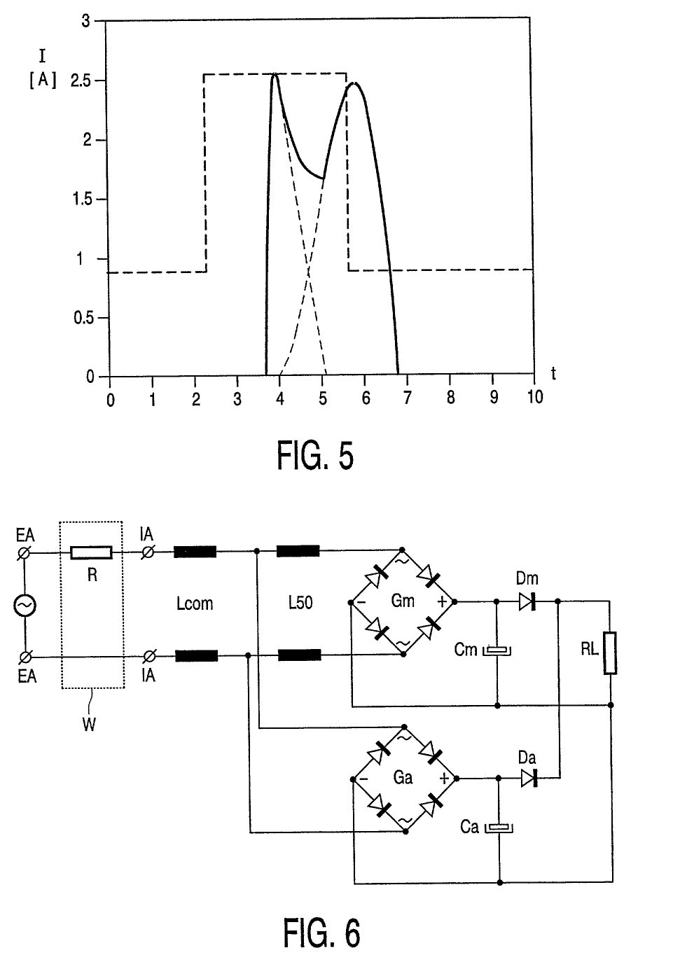

FIG. 5 shows the curve of the power consumption in the circuit shown in FIG. 4,

FIG. 6 shows a second circuit according to the invention with one consumer, FIG. 7 shows the curve of the power consumption occurring in the circuit shown in FIG. 6,

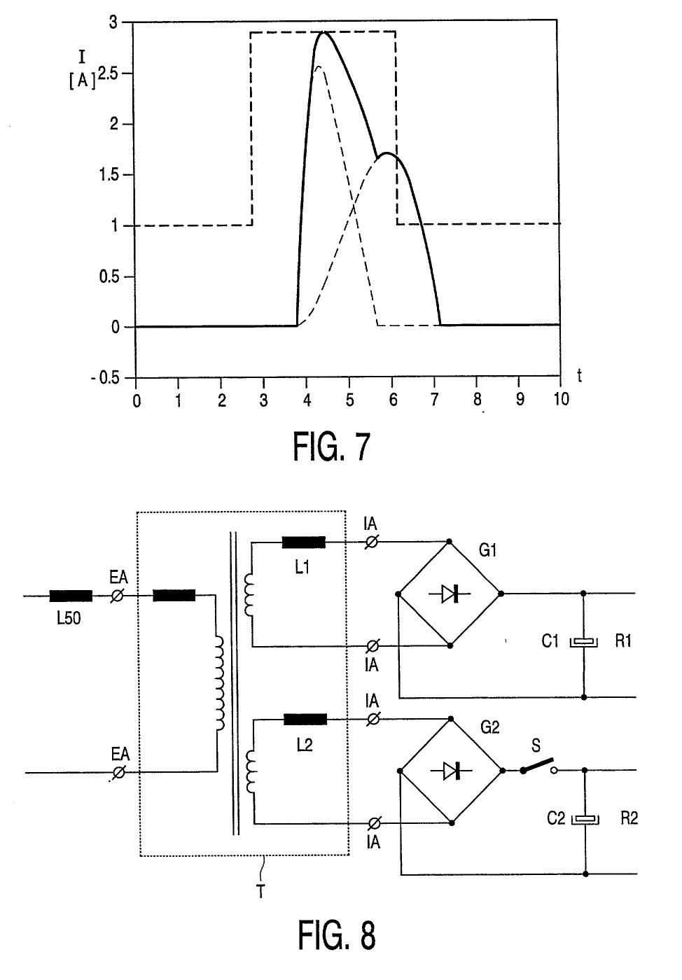

FIG. 8 shows a third circuit according to the invention with two consumers and one input-side transformer, and

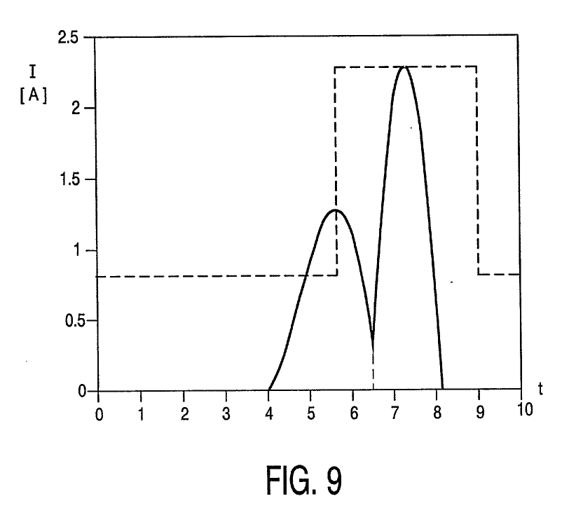

FIG. 9 shows the curve of the power consumption in the circuit shown in FIG. 8.

The generation of DC voltages for supplying power to electronic terminal devices from an AC mains voltage is to satisfy certain minimum criteria with respect to the conversion of the AC voltage into DC voltage. For consumers with more than 75 W power consumption these requirements are expressed, for example, in the standard CEI/IEC 61000-3-2, SECOND EDITION, 2000-08. Various methods of satisfying this standard are about generating as exact a sinusoidal input current as possible. Meanwhile, the standard has not made this a compulsory sinusoidal form.

A widely known method of satisfying quality instructions consists of a passive solution using a so-termed 50 Hz coil which smoothes the input current. However, a high inductance is then necessary to satisfy, for example, the CEI/IEC 61000-3-2, SECOND EDITION, 2000-08. The respective coil is thus very large and heavy, which leads to problems when accommodating it on a printed circuit board and also with shock tests of the devices. The present invention renders a circuit available, which makes it possible to use smaller coils while at the same time satisfying quality instructions for the conversion.

In the standard CEI/IEC 61000-3-2, SECOND EDITION, 2000-08, classes A to D are distinguished, while a device belonging to a class depends on various features (for example, portability of the device). For many terminal devices such as, for example, TV sets, in essence the classes A and D are options while their depending on one or the other class depends on whether the signal shape of the current consumption from an AC voltage source either or not deviates more than 5% from a reference curve defined in the standard. The reference curve is plotted as a dotted square-wave curve in the FIGS. 3, 5, 7 and 9. If the signal shape of a power consumption is more than 5% outside the reference curve, the device belongs to class A. In this class there are more generous boundary values for the higher harmonic still permissible in the signal.

FIG. 1 shows a prior-art circuit for supplying two consumers Rm, Ra with a DC voltage that is obtained from the conversion from an AC voltage source. This circuit corresponds to the circuit of FIG. 2 in which the two consumers Rm, Ra are connected in parallel to the outputs of the rectifier module G.

FIG. 2 gives a more detailed version of the prior-art circuit for supplying a consumer L with a DC voltage. The power is taken from an AC voltage source AC and converted by a rectifier module G into an uncontrolled or fluctuating DC voltage (having ripple). The AC voltage is fed to the input connections of the rectifier G. In one of the input lines or in the two input lines there is a 50 Hz coil L50 for the smoothing operation. The DC voltage can be tapped by the consumer R1 from the output terminals “+”, “−” of the rectifier module G. The two output lines to these terminals may be coupled via a smoothing capacitor C. Furthermore, a resistor R is often to be found in an output line to realize a limitation of the switch-on current.

The form of the curve resulting from a circuit shown in FIG. 1 or FIG. 2, respectively, is shown in FIG. 3 in which the circuit is based on the following parameters: R 1.5 Ohms, L50=32 mH, C=220μF., Uin=230 V, f=50 Hz, Po=145 W. The dotted line also shown in FIG. 3 corresponds to the reference curve form of the standard CEI/IEC 61000-3-2, SECOND EDITION, 2000-08, on the basis of which the classes A and D are distinguished. Since the represented signal form of the circuits shown in FIGS. 1 and 2 remains within the reference curve form, it is to satisfy the requirements of class D in accordance with the CEI/IEC 61000-3-2, SECOND EDITION, 2000-08.

FIG. 4 represents a first circuit according to the invention for supplying power to two consumers Rm, Ra. In this circuit there are two different paths over which energy is tapped from the mains supply. The first path passes through the first rectifier module Gm (m=main), the second path through the second rectifier module Ga (a=aux). Only the first path runs through the 50 Hz coil L50, whereas the auxiliary power for the second path is tapped before the 50 Hz coil L50. In the input of the circuit an AC voltage supply W is denoted by two external connections EA for the AC voltage source AC and two internal connections IA for the rectifier module Gm, Ga. In this case the AC voltage supply has only one resistor R which limits the input current at the turn-on instant.

FIG. 5 shows the resulting signal pattern of the power consumption (50 Hz input current, a half-wave) when the circuit shown in FIG. 4 is used. The resulting curve form of the input current (solid line) consists of two parts (dotted line for the current pattern in the respective paths). The peaks of these two parts occur at different times because the recharging pulse for the second path via the rectifier Ga is limited only by the small stray inductance Lcom of the coil to suppress common mode interference, whereas the main recharging pulse is limited by the large 50 Hz coil L50.

It is possible to set the form of the curve in various ways in dependence on the selected power level and the component parameters. The curve form shown in FIG. 5 has a more than 5% deviation from the dotted reference curve according to standard CEI/IEC 61000-3-2, SECOND EDITION, 2000-08, so that its class A can be used.

FIG. 6 shows an alternative arrangement of the circuit according to the invention, in which a single consumer R1 is operated by two parallel current paths via the rectifiers Ga and Gm as they are arranged in FIG. 4. For this purpose, the “+” terminals of the two rectifiers Gm, Ga are directly coupled together via the diodes Dm, Da and the “−” terminals. FIG. 7 shows the curve form of the input current belonging to this circuit.

A third variant of the circuit is shown in FIG. 8. In this variant the AC voltage is fed to the ends of the primary winding of the transformer T and tapped from two secondary windings of the transformer T. The transformer thus forms, differently from the FIGS. 4 and 6, an AC voltage supply transforming the signal (dotted box). Two rectifier modules G1 and G2, whose input lines include respective stray inductances L1 and L2, are connected to the two secondary windings. If necessary, a choke L50 may be present on the primary side of the transformer T. Furthermore, a switch S is arranged in an output line of a rectifier G2.

The resultant curve form of the input current is shown in FIG. 9. The circuit is slightly complicated, but has various advantages. The basic method may be used with 50 Hz transformers which are nowadays still used in audio equipment. Furthermore, the switch S may be used for maintaining the voltage running through the second electrolyte capacitor C2 within a smaller range. This in its turn specifically with the above-mentioned audio equipment leads to a smaller power dissipation in the linear controllers downstream in the circuit.

Obviously, the principle may also be used in systems without a 50 Hz transformer, for example, in television sets having the above-mentioned specifications. In the case of an auxiliary power supply the switch can be used for limiting the maximum electrolyte capacitor voltage to a value, for example, in the neighborhood of 300 V poles and thus simplify the auxiliary DC/DC converter.

With all proposals the use of non-linear inductances (i.e. inductance depends on current) may be used for further reducing the size of the magnetic components.

Legend:

| | |
|---|---|
| AC | AC voltage source |
| C | smoothing capacitor |
| Ca, C2 | capacitor in the second input path |
| Cm, C1 | capacitor in the first input path |
| Dm, Da | diodes in the first/second input path |
| EA | external connection |
| G | rectifier |
| Ga, G1 | rectifier in the first input path (“main”) |
| Gm, G2 | rectifier in the second input path (“aux”) |
| I | current |
| IA | internal connection |
| L | inductance |
| L50 | 50 Hz coil |
| Lcom | stray inductance of the coil to suppress common mode |
| | interference |
| R | ohmic resistance |
| R1 | consumer |
| Rm, Ra | consumer in the first/second input path |
| S | switch |
| T | transformer |
| t | time |
| W | AC voltage supply |

1. A circuit for converting an AC voltage into an uncontrolled DC voltage for at least one consumer, comprising
an AC power supply (W;T) having two external connections (EA)and at least two internal connections (IA),
a rectifier module (Gm;G1) whose two inputs are connected to a respective internal connection of the AC power supply and which has two output lines with external connections for coupling at least one consumer (Rm;RL;R1) to them,
at least an induction coil (L50;L1,L2) arranged in at least one of the connection lines between the internal connections of the AC power supply and the rectifier module (Gm),
characterized in that at least a second rectifier module (Ga; G2) is available whose two inputs are connected to a respective internal connection of the AC voltage supply and which has two output lines for the connection of at least one consumer (Ra, RI; R2).

2. A circuit as claimed in claim 1, characterized in that the output lines of at least one of the rectifier modules (Gm, Ga; G1, G2) are coupled via a smoothing capacitor (Cm, Ca; C1; C2).

3. A circuit as claimed in one of the claims 1 or 2, characterized in that a diode (Dm, Da) is arranged in at least one output line of a rectifier module (Gm, Ga).

4. A circuit as claimed in at least one of the claims 1 to 3, characterized in that the output lines which have the same polarity as the rectifier modules (Gm, Ga) are connected together while the connection is preferably effected via diodes (Dm, Da).

5. A circuit as claimed in at least one of the claims 1 to 4, characterized in that the AC voltage supply (W) comprises a through-connection between two internal connections (IA) and two respective external connections (EA).

6. A circuit as claimed in at least one of the claims 1 to 5, characterized in that the AC voltage supply is formed by a transformer (T) whose primary winding ends form the two external connections (EA) and which includes at least two secondary windings whose ends form four internal connections (IA).

7. A circuit as claimed in claim 6, characterized in that an induction coil (L2) is arranged in the connecting line between the second rectifier module (G2) and the associated internal connector of the transformer (T).

8. A circuit as claimed in claim 6, characterized in that the induction coil arranged in one of the connecting lines between the internal connections (IA) of the AC voltage supply and the rectifier module (GI) is in the form of stray inductances (L1, L2).

9. A circuit as claimed in at least one of the claims 1 to 8, characterized in that a switch (S) is arranged in an output line of the second rectifier module (Ga, G2).
